(19) United States
(12) Patent Application Publication
(10) Pub. No.: US 2010/0083176 A1
(43) Pub. Date: Apr. 1, 2010

(54) Apparatus and method for displaying a contents list on screen in mobile communication terminal

(75) Inventor: Jung-Hun Park, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/587,029

(22) Filed: Sep. 30, 2009

(30) Foreign Application Priority Data
Sep. 30, 2008 (KR) 10-2008-0095859

(51) Int. Cl. G06F 3/048

(52) U.S. Cl. 715/810

(57) ABSTRACT

A mobile terminal includes an apparatus and a method for displaying a contents list on a screen. In the method, specification information required for executing relevant content is determined by parsing a Right Object (RO) of the content. Whether the relevant content is executable is determined using the determined specification information. A determination result is displayed on the contents list and the contents list is output on the screen.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Sep. 30, 2008 and assigned Serial No. 10-2008-0095859, the entire disclosure of which is hereby incorporated by reference.

### TECHNICAL FIELD OF THE INVENTION

The present invention relates to a method and an apparatus for displaying a contents list on a screen in a mobile communication terminal. More particularly, the present invention relates to an apparatus and a method for incorporating specification information required for executing relevant contents into a Right Object (RO) of contents, determining ‘executable’, ‘inexecutable’, and ‘execution unsuitable’ of the relevant contents using the specification information, and displaying a determination result on a contents list and outputting the contents list on a screen.

### BACKGROUND OF THE INVENTION

As the performance of a mobile terminal improves, a user's demand for using lots of contents through a mobile terminal has rapidly increased, and a Digital Rights Management (DRM) technique has emerged in order to block use, distribution, and sharing of illegal content for which a reasonable price has not been paid.

The DRM technique allows a user to pay a cost for content to be used by the user and to purchase a Right Object (RO) of a relevant content. When the RO is purchased, content and the RO for the relevant content are transmitted to a terminal are stored and managed in different regions inside the terminal, respectively. That is, the contents are stored in a region accessible by a user, and the RO of the relevant contents is stored in a region inaccessible by the user. Therefore, the RO of the relevant contents cannot be moved to a different device.

Recently, as a follow-on technique after the DRM technique, a Secure Removable Media (SRM) technique that can support movement of content and an RO between devices is under development. Therefore, a user may move content and an RO downloaded to a terminal to a different device, and execute the relevant content.

However, as movement of content and an RO between devices becomes possible, various problems may be created. For example, content received from a different service provider that is not the current service provider may be executable in a terminal. Such a case is an unexpected circumstance for a service provider that has issued the RO. Accordingly, a problem may be created for the collection of metering information provided to a content author by an RO issuer and used for copyright fee calculation. Additionally, when content is executed in a terminal of a different service provider, an error may be created in a portion of content. Even when an error is not created while the content is executed, the contents that depend on specification of a model, such as a screen size, an audio, and the like, are used in a different model whose specification is not the same, therefore the quality may be deteriorated. In this case, a user may not want to consume an RO. Additionally, since a contents list displayed on a current screen does not display whether each content is executable or not, a user may execute the contents regardless of whether the contents are executable. Accordingly, unwanted consumption of an RO by the user may be created.

### SUMMARY OF THE INVENTION

To address the above-discussed deficiencies of the prior art, it is a primary aspect of the present invention is to address at least the above-mentioned problems and/or disadvantages and to provide at least the advantages described below. Accordingly, an aspect of the present invention is to provide an apparatus and a method for displaying a contents list on a screen in a mobile communication terminal.

Another aspect of the present invention is to provide an apparatus and a method for incorporating specification information required for executing relevant content into a Right Object (RO) of a content, allowing a mobile communication terminal to determine ‘executable’, ‘inexecutable’, and ‘execution unsuitable’ of the relevant content using the specification information, and display a determination result on a contents list and output the contents list on a screen.

In accordance with an aspect of the present invention, a method for displaying a contents list on a screen in a mobile communication terminal is provided. The method includes: determining specification information required for executing relevant content by parsing a Right Object (RO) of the content; determining whether the relevant content is executable using the determined specification information; and displaying a determination result on the contents list and outputting the contents list on the screen.

In accordance with another aspect of the present invention, an apparatus for displaying a contents list on a screen in a mobile communication terminal is provided. The apparatus includes: a content manager for determining specification information required for executing relevant content by parsing a Right Object (RO) of the content, determining whether the relevant content is executable using the determined specification information, and displaying a determination result on the contents list; and a display unit for outputting the contents list on the screen.

Other aspects, advantages and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an apparatus of a mobile communication terminal according to an exemplary embodiment of the present invention;

FIG. 2 illustrates a flowchart of a method for displaying a contents list on a screen and executing content in response to a content execution request in a mobile communication terminal according to an exemplary embodiment of the present invention; and

FIG. 3 illustrates a view of a screen display of a contents list in a mobile communication terminal according to an exemplary embodiment of the present invention.

Throughout the drawings, like reference numerals will be understood to refer to like parts, components and structures.

### DETAILED DESCRIPTION OF THE INVENTION

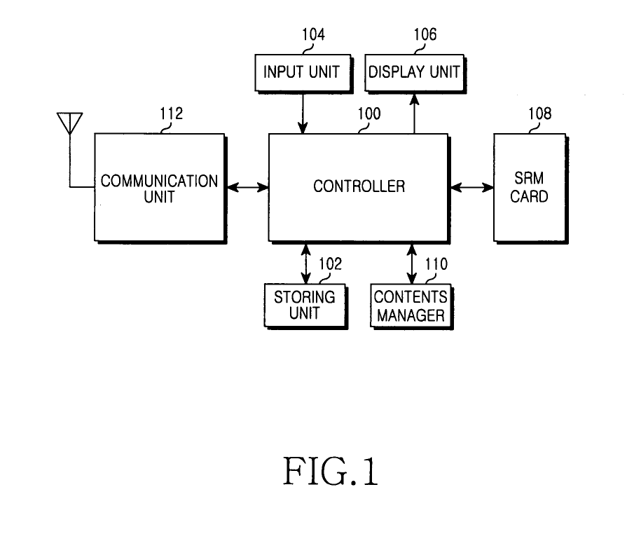

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication terminal.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Exemplary embodiments of the present invention provide an apparatus and a method for incorporating specification information required for executing relevant content into a Right Object (RO) of the content, allowing a mobile communication terminal to determine ‘executable’, ‘inexecutable’, and ‘execution unsuitable’ of the relevant content using the specification information, and display a determination result on a contents list and output the contents list on a screen.

FIG. 1 illustrates a block diagram of an apparatus of a mobile communication terminal according to an exemplary embodiment of the present invention.

As illustrated in FIG. 1, the terminal includes a controller 100, a storing unit 102, an input unit 104, a display unit 106, a Secure Removable Media (SRM) card 108, a content manager 110, and a communication unit 112.

Referring to FIG. 1, the controller 100 controls and processes an overall operation of the mobile communication terminal. In addition to a general function, the controller 100 controls and processes functions for determining ‘executable’, inexecutable', and ‘execution unsuitable’ of relevant content using the specification information required for executing each content, and displaying a determination result on a contents list and outputting the contents list on a screen.

The storing unit 102 stores microcodes of programs for the process and control of the controller 100, and various reference data. More particularly, the storing unit 102 stores content and an RO according to an exemplary embodiment of the present invention.

The input unit 104 includes a plurality of function keys such as numerical key buttons of 0 to 9, a menu button, a cancel (delete) button, an OK button, a TALK button, an END button, an Internet access button, navigation (or direction) key buttons (▴/▾/ [symbol] / [symbol] ), and provides key input data corresponding to a key pressed by a user to the controller 100.

The display unit 106 displays state information generated during an operation of the terminal, a limited number of letters, a large amount of moving images and still images, and the like. More particularly, the display unit 106 outputs a contents list on which ‘executable’, ‘inexecutable’, and ‘execution unsuitable’ for each content can be displayed on a screen according to an exemplary embodiment of the present invention. Here, the display unit 106 may be a color Liquid Crystal Display (LCD).

The SRM card 108 can be a detachable external memory that stores content and an RO, and guarantees safe movement of the stored content and RO to a different device.

The content manager 110 downloads content and an RO of the content from an RO issuer, and stores them in the storing unit 102 and the SRM card 108. Thereafter, the content manager 110 extracts content and an RO from the storing unit 102 and the SRM card 108 according to a content execution request, determines specification information required for executing relevant content by parsing the extracted RO, and determines ‘executable’, ‘inexecutable’, and ‘execution unsuitable’ of the relevant content using the determined specification information. Thereafter, the content manager 110 displays the determination result on a contents list and outputs the contents list on the screen, and executes the relevant contents according to the determination result.

The communication unit 112 down-converts a Radio Frequency (RF) signal received via an antenna to provide the down-converted signal to the controller 100, and up-converts a baseband signal from the controller 100 to transmit the up-converted signal via the antenna.

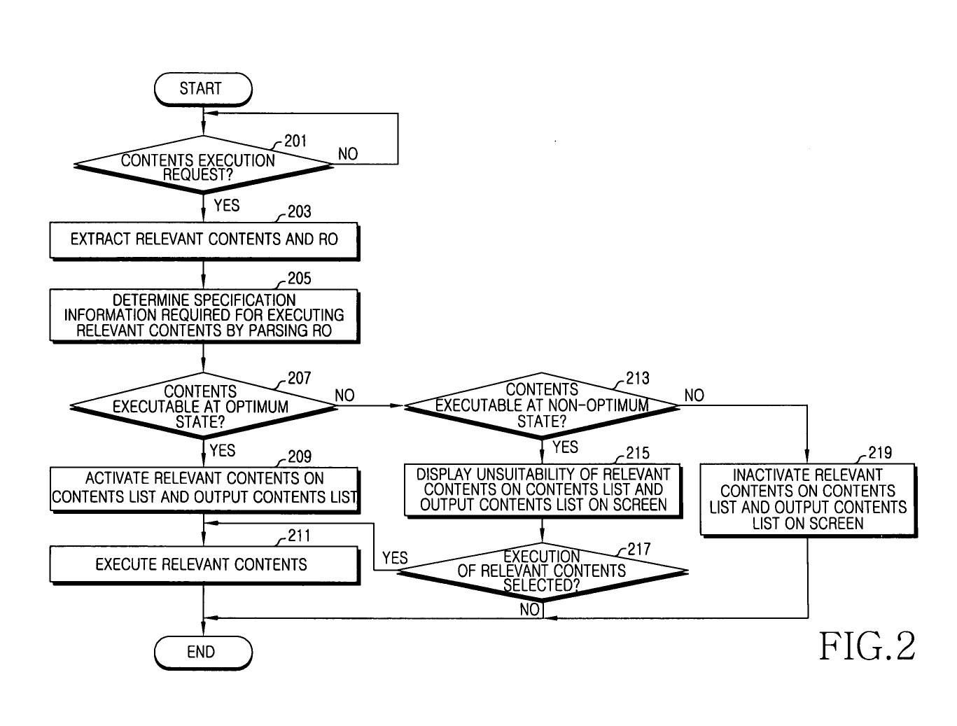

FIG. 2 illustrates a flowchart of a method for displaying a contents list on a screen and executing content in response to a content execution request in a mobile communication terminal according to an exemplary embodiment of the present invention.

Referring to FIG. 2, the terminal determines whether a content execution request is detected according to a user's key manipulation in step 201. When the content execution request is detected, the terminal extracts relevant content and an RO thereof from the SRM card 108 or the storing unit 102 in step 203.

Here, as illustrated in Table 1, the RO of the content further includes specification information required for executing the relevant content in addition to general right information according to an exemplary embodiment of the present invention.

TABLE 1

| Specification | |
|---|---|
| Information | Description |
| LCD Width | a width of a LCD on which the contents are displayed. |
| LCD Height | a height of a LCD on which the contents are displayed. |
| Codec | a compression scheme of the contents |
| Model | a model name suitable for the contents |
| Operator | a service provider suitable for the contents |

The terminal determines specification information required for executing relevant content by parsing the extracted RO in step 205.

The terminal determines whether the relevant content is executable at an optimum state by comparing the determined specification information with capability information of the terminal itself in step 207. That is, the terminal determines whether the terminal meets all specifications required for executing the content and executes the content at the original state.

When it is determined that the relevant content is executable at the optimum state in step 207, the terminal activates the relevant content on a contents list and displays the contents list on the screen in step 209. The terminal executes the relevant content in step 211, and ends the process according to an exemplary embodiment of the present invention.

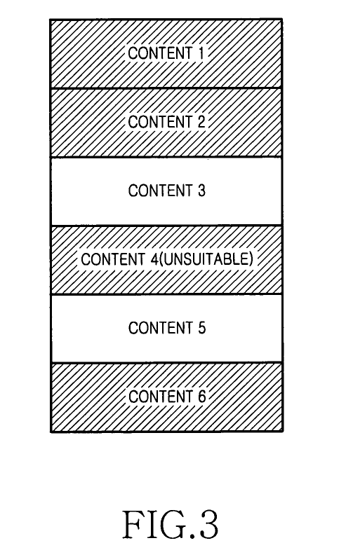

Here, an example contents list is described with reference to FIG. 3. Respective contents listed on the contents list are activated or inactivated, and even when content is activated, the content can be displayed as unsuitable. Here, activation of the content denotes that the relevant content is executable, and inactivation of the content denotes that the relevant content is not executable. In addition, ‘unsuitable’ can be displayed even though the content is activated. This case denotes that the relevant content is not suitable for the terminal because a specification of the content and a capability of the terminal do not match with each other, but may be executable through format conversion of the relevant content.

Alternatively, when it is determined that the relevant content is not executable at the optimum state in step 207, the terminal determines whether the relevant content is executable at a non-optimum state by comparing the determined specification information with capability information of the terminal itself in step 213. That is, the terminal determines whether the terminal does not meet all or a portion of specifications required for executing the content and whether the content is executable even in a transformed form, though not the original form, through format conversion of the content.

When it is determined that the relevant content is executable at the non-optimum state in step 213, the terminal displays unsuitableness of the relevant content on the contents list in step 215, that is, displays that the capability of the terminal itself is not suitable for executing the relevant content on the contents list, and outputs the contents list on the screen. At this point, the terminal displays a query as to whether to execute the relevant content, even in the non-optimum state, together with the contents list on the screen. The terminal determines whether execution of the relevant content is selected by a user's key manipulation in step 217, and when the selection of the execution of the relevant content is detected, converts the format of the relevant content into a format suitable for the capability of the terminal and executes the content at the converted format in step 211. In contrast, when the selection of the execution of the relevant content is not detected, the terminal ends the process according to an exemplary embodiment of the present invention.

When it is determined that the relevant content is not executable even in the non-optimum state in step 213, the terminal inactivates the relevant content on the contents list and outputs the contents list on the screen in step 219. Thereafter, the terminal ends the algorithm according to an exemplary embodiment of the present invention.

As described above, an exemplary embodiment of the present invention provides an advantage of preventing in advance a problem generated as movement of content and an RO becomes possible by incorporating specification information required for executing relevant content into the RO of the content, allowing a mobile communication terminal to determine ‘executable’, ‘inexecutable’, and ‘execution unsuitable’ of the relevant content using the specification information, and display a determination result on a contents list and output the contents list on a screen. That is, the exemplary embodiment of the present invention can address a metering problem that may be generated during execution of content, and an unwanted consumption of an RO that may be generated by execution of unsuitable content.

Although the present disclosure has been described with an exemplary embodiment, various changes and modifications may be suggested to one skilled in the art. It is intended that the present disclosure encompass such changes and modifications as fall within the scope of the appended claims

What is claimed is:

1. A method for displaying a contents list on a screen in a mobile communication terminal, the method comprising:
determining specification information required for executing relevant content by parsing a Right Object (RO) of the content;
determining whether the relevant content is executable using the determined specification information; and
displaying a determination result on the contents list and outputting the contents list on the screen.

2. The method of claim 1, further comprising, when a content execution request is detected, extracting the content and an RO of the content from a storing unit.

3. The method of claim 1, wherein the specification information required for executing the content comprises at least one of a width of a screen on which the content is displayed, a height of a screen on which the content is displayed, a compression scheme of the content, a model name suitable for the content, and a service provider suitable for the content.

4. The method of claim 1, wherein determining whether the relevant content is executable using the determined specification information comprises determining whether capability of the terminal itself meets specification required for executing the content by comparing the determined specification information with capability information of the terminal itself.

5. The method of claim 4, wherein the displaying of the determination result on the contents list and outputting of the contents list on the screen comprises:
when the capability of the terminal itself meets all specifications required for executing the content, activating the relevant content on the contents list, and outputting the contents list on the screen;
when the capability of the terminal itself meets a portion of the specification required for executing the content determining a conversion of a format of the content is required.

6. The method of claim 5, further comprising
activating the relevant content on the contents list; and
displaying that the terminal is not suitable for executing the relevant contents on the contents list, and outputting the contents list on the screen.

7. The method of claim 4, further comprising
when the capability of the terminal itself does not meet all the specifications required for executing the contents, inactivating the relevant contents on the contents list, and outputting the contents list on the screen.

8. An apparatus for displaying a contents list on a screen in a mobile communication terminal, the apparatus comprising:
a content manager configured to determine specification information required for executing relevant content by parsing a Right Object (RO) of the content, the content manager further configured to determine whether the relevant content is executable using the determined specification information, and display a determination result on the contents list; and
a display unit configured to output the contents list on the screen.

9. The apparatus of claim 8, further comprising a storage unit configured to store content and an RO of the content,
wherein the content manager is configured to extract the content and the RO of the content from the storage unit when a content execution request is detected.

10. The apparatus of claim 8, wherein the specification information required for executing the content comprises at least one of a width of a screen on which the content is displayed, a height of a screen on which the content is displayed, a compression scheme of the content, a model name suitable for the content, and a service provider suitable for the content.

11. The apparatus of claim 8, wherein the content manager is configured to determine whether the relevant content is executable by comparing the determined specification information with capability information of the terminal itself and determining whether capability of the terminal itself meets specification required for executing the content.

12. The apparatus of claim 11, wherein when the capability of the terminal meets the specifications required for executing the content, the contents manager activates the relevant content on the contents list, and outputs the contents list on the screen.

13. The apparatus of claim 11, wherein when the capability of the terminal itself meets a portion of the specification required for executing the content, the content manager is configured to determine a conversion of a format of the content is required, and the content manager activates the relevant content on the contents list, displays that the terminal is not suitable for executing the relevant content on the contents list, and outputs the contents list on the screen.

14. The apparatus of claim 11, wherein when the capability of the terminal itself does not meet all the specifications required for executing the content, the contents manager inactivates the relevant contents on the contents list, and outputs the contents list on the screen.

15. A portable terminals capable of displaying a contents list on a screen, the portable terminal comprising:
a content manager configured to determine specification information required for executing relevant content by parsing a Right Object (RO) of the content, the content manager further configured to determine whether the relevant content is executable using the determined specification information, and display a determination result on the contents list; and
a display unit configured to output the contents list on the screen.

16. The portable terminal of claim 15, further comprising a storage unit configured to store content and an RO of the content,
wherein the content manager is configured to extract the content and the RO of the content from the storage unit when a content execution request is detected.

17. The portable terminal of claim 15, wherein the specification information required for executing the content comprises at least one of a width of a screen on which the content is displayed, a height of a screen on which the content is displayed, a compression scheme of the content, a model name suitable for the content, and a service provider suitable for the content.

18. The portable terminal of claim 15, wherein the content manager is configured to determine whether the relevant content is executable by comparing the determined specification information with capability information of the terminal itself and determining whether capability of the terminal itself meets specification required for executing the content.

19. The portable terminal of claim 18, wherein when the capability of the terminal meets the specifications required for executing the content, the contents manager activates the relevant content on the contents list, and outputs the contents list on the screen.

20. The portable terminal of claim 18, wherein when the capability of the terminal itself meets a portion of the specification required for executing the content, the content manager is configured to determine a conversion of a format of the content is required, and the content manager activates the relevant content on the contents list, displays that the terminal is not suitable for executing the relevant content on the contents list, and outputs the contents list on the screen.

21. The portable terminal of claim 18, wherein when the capability of the terminal itself does not meet all the specifications required for executing the content, the contents manager inactivates the relevant contents on the contents list, and outputs the contents list on the screen.
